(19) United States
(12) Patent Application Publication
(10) Pub. No.: US 2026/0142392 A1
(43) Pub. Date: May 21, 2026

(54) POWER CABLE ASSEMBLY

(71) Applicant: BIZLINK INTERNATIONAL CORP., New Taipei City (TW)

(72) Inventors: Hongping SU, New Taipei City (TW); Haoran ZOU, New Taipei City (TW); Qixing XU, New Taipei City (TW)

(21) Appl. No.: 18/948,557

(22) Filed: Nov. 15, 2024

(51) Int. Cl. H01R 11/32; H01R 11/09

(52) U.S. Cl. CPC H01R 11/32; H01R 11/09

(57) ABSTRACT

A power cable assembly includes a housing and two terminal sets. The housing includes a main body portion and a plurality of extending portions. The two terminal sets are embedded into the housing and exposed via two openings of the extending portions. Each of the two terminal sets includes an outer terminal plate and an inner terminal plate. The outer terminal plate comprises a plurality of first elastic arms, and a plurality of second elastic arms. The inner terminal plate is stacked with the outer terminal plate. A plurality of outer apertures are formed between each two of the first elastic arms. The inner terminal plate comprises a plurality of third elastic arms. A plurality of inner apertures are formed between each two of the third elastic arms. The second elastic arms are embedded into the inner apertures respectively.

### BACKGROUND

### Field of Invention

The present invention relates to a power cable assembly, and specifically, to a busbar clip power cable assembly.

### Description of Related Art

Generally, a server's busbar clip connector mainly comprises of two conductive terminal sets designed to clamp the copper busbar. For instance, power connectors such as BizLink's BzLisa 600S feature a main body with grounded and power terminal sets securely positioned on or inside the main body. These connectors are widely used in various applications.

However, with the increasing demand for higher current capacity and more efficient heat dissipation, there is a growing need for enhanced connector assemblies. This has driven the industry to actively invest in research and development to meet these evolving functional requirements.

### SUMMARY

In view of this, one purpose of the present disclosure is to provide a power cable assembly that can solve the aforementioned problems.

In order to achieve the above objective, according to an embodiment of the present disclosure, a power cable assembly includes a housing and two terminal sets. The housing includes a main body portion and a plurality of extending portions. The extending portions protrude from the main body portion and have two openings opposite to each other. The two terminal sets are embedded into the housing and are exposed via the two openings of the extending portions, respectively. Each of the two terminal sets includes an outer terminal plate and an inner terminal plate. The outer terminal plate includes an outer fixing portion, a plurality of first elastic arms, and a plurality of second elastic arms. The first elastic arms and the second elastic arms are extended from the outer fixing portion. A plurality of outer apertures are formed between each two of the first elastic arms. The second elastic arms are aligned with and cover a majority portion of the outer apertures. The inner terminal plate is stacked with the outer terminal plate. The inner terminal plate includes an inner fixing portion and a plurality of third elastic arms. A plurality of inner apertures are formed between each two of the third elastic arms. The second elastic arms are embedded into the inner apertures respectively. The outer terminal plate further includes a plurality of first contacting portions located at an end of the first elastic arms away from the main body portion of the housing and a plurality of second contacting portions located at an end of the second elastic arms away from the main body portion of the housing. The inner terminal plate further includes a plurality of third contacting portions located at an end of the third elastic arms away from the main body portion of the housing.

In summary, in the power cable assembly of the present disclosure, since the second contacting portion is separated from the first contacting portion and the third contacting portion is located between the first contacting portion and the second contacting portion, the contact area between the connector and the copper busbar can be increased, thereby achieving the purpose of conducting larger current. In addition, the power cable assembly of the present disclosure also achieves the purpose of reducing resistance force of plugging.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a power cable assembly in accordance with an embodiment of the present disclosure;

FIG. 2 is an exploded view of the power cable assembly in accordance with an embodiment of the present disclosure;

FIG. 3 is a perspective view of a terminal in accordance with an embodiment of the present disclosure;

FIG. 4 is an exploded view of the terminal in accordance with an embodiment of the present disclosure;

FIG. 5 is a sided view of the terminal in accordance with an embodiment of the present disclosure;

FIG. 6 is a sided view of the power cable assembly in accordance with an embodiment of the present disclosure;

FIG. 7 is another sided view of the power cable assembly in accordance with an embodiment of the present disclosure;

FIG. 8 is a cross-sectional view of the power cable assembly in accordance with an embodiment of the present disclosure; and

FIG. 9 is a perspective view of the power cable assembly in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in the power cable assembly CA of this embodiment and the connection relationship between the components will be described in detail.

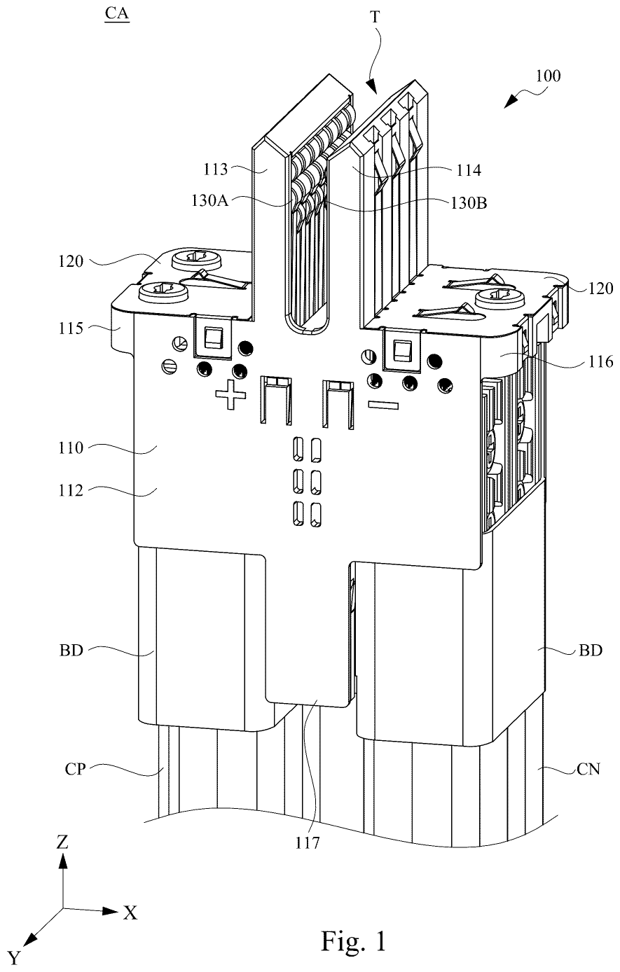

Reference is made to FIG. 1. FIG. 1 is a perspective view of a power cable assembly CA in accordance with an embodiment of the present disclosure. As shown in FIG. 1, in this embodiment, the power cable assembly CA includes a connector 100, a positive cable assembly CP, and a negative cable assembly CN. The connector 100 includes a housing 110, two ground elastic sheets 120, a positive terminal set 130A, and a negative terminal set 130B. The housing 110 includes a main body portion 112, a first extending portion 113, a second extending portion 114, a wing portion 115, a wing portion 116, and an extending cover plate 117. The first extending portion 113 and the second extending portion 114 protrude from a top of the main body portion 112. The first extending portion 113 is separated from the second extending portion 114. In some embodiments, the first extending portion 113 and the second extending portion 114 have two openings (not shown) opposite to each other. The wing portion 115 and the wing portion 116 laterally surround the first extending portion 113 and the second extending portion 114. The wing portion 115 is located between the main body portion 112 and the first extending portion 113. The wing portion 116 is located between the main body portion 112 and the second extending portion 114. The main body portion 112, the first extending portion 113, and the second extending portion 114 jointly define a trench T. The extending cover plate 117 extends from the main body portion 112. In some embodiments, the extending cover plate 117 protrudes beyond the main body portion 112.

Reference is made again to FIG. 1. As shown in FIG. 1, in this embodiment, the two ground elastic sheets 120 are disposed on the housing 110. Specifically, the two ground elastic sheets 120 are respectively disposed on the first extending portion 113 and the second extending portion 114. More specifically, one of the two ground elastic sheets 120 is disposed on the first extending portion 113 and the top of the main body portion 112, and the other one of the two ground elastic sheets 120 is disposed on the second extending portion 114 and the top of the main body portion 112. The positive terminal set 130A and the negative terminal set 130B are located on the housing 110. More specifically, the positive terminal set 130A and the negative terminal set 130B are respectively located on the first extending portion 113 and the second extending portion 114. In some embodiments, the positive terminal set 130A and the negative terminal set 130B are embedded into the housing 110 and exposed via the two openings of the first extending portion 113 and the second extending portion 114 respectively. The positive terminal set 130A and the negative terminal set 130B are located in the trench T and face to each other. In some embodiments, the positive terminal set 130A and the negative terminal set 130B are partly located in the trench T. The positive terminal set 130A and the negative terminal set 130B are separated. The two ground elastic sheets 120 are separated from the positive terminal set 130A and the negative terminal set 130B.

Reference is made again to FIG. 1. As shown in FIG. 1, in this embodiment, the positive cable assembly CP is electrically connected to the positive terminal set 130A, and the negative cable assembly CN is electrically connected to the negative terminal set 130B. In this embodiment, the power cable assembly CA further includes two sealing sleeves BD. One of the two sealing sleeves BD is connected to the positive cable assembly CP, and the other one of the two sealing sleeves BD is connected to the negative cable assembly CN. In some embodiments, the positive cable assembly CP and the negative cable assembly CN are bound with the two sealing sleeves BD.

In some embodiments, the positive terminal set 130A and the negative terminal set 130B extend from the top of the main body portion 112 and protrude away from a bottom of the main body portion 112. More specifically, the positive terminal set 130A and the negative terminal set 130B protrude downward from the main body portion 112, so that the positive terminal set 130A and the negative terminal set 130B are exposed. In some embodiments, the extending cover plate 117 extends downward form the main body portion 112, so that a bottom portion of the positive terminal set 130A and a bottom portion of the negative terminal set 130B are covered by the extending cover plate 117. In some other embodiments, the connector 100 does not include the extending cover plate 117, so that the bottom portion of the positive terminal set 130A and the bottom portion of the negative terminal set 130B are fully exposed.

As shown in FIG. 1, in some embodiments, the first extending portion 113 and the second extending portion 114 protrude from the main body portion 112 along a direction (e.g., z-direction). In some embodiments, the first extending portion 113 and the second extending portion 114 are arranged in a direction (e.g., x-direction). The wing portion 115 and the wing portion 116 laterally extend from the main body portion 112 and are perpendicular to the first extending portion 113 and the second extending portion 114.

In some embodiments, the housing 110 may be, for example, an insulator or other suitable material. The present disclosure is not intended to limit the material of the housing 110.

In some embodiments, the two ground elastic sheets 120 may be composed of, for example, a metallic material, an alloy material, or other suitable materials. The present disclosure is not intended to limit the material of the two ground elastic sheets 120.

In some embodiments, the positive terminal set 130A and the negative terminal set 130B may be, for example, brass or other suitable conductive materials. The present disclosure is not intended to limit the material of the positive terminal set 130A and the negative terminal set 130B.

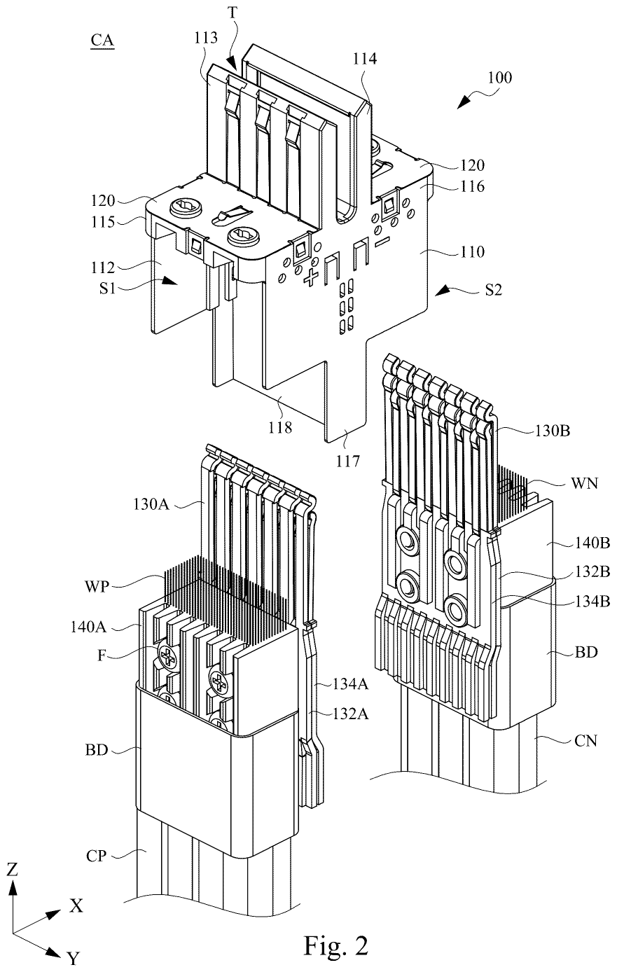

Reference is made to FIG. 2. FIG. 2 is an exploded view of the power cable assembly CA in accordance with an embodiment of the present disclosure. As shown in FIG. 2, in this embodiment, the positive terminal set 130A includes an outer terminal plate 132A and an inner terminal plate 134A. The outer terminal plate 132A and the inner terminal plate 134A are stacked with each other. The outer terminal plate 132A is connected to the positive cable assembly CP, so that the outer terminal plate 132A is located between the positive cable assembly CP and the inner terminal plate 134A. The negative terminal set 130B includes an outer terminal plate 132B and an inner terminal plate 134B. The outer terminal plate 132B and the inner terminal plate 134B are stacked with each other. The outer terminal plate 132B is connected to the negative cable assembly CN, so that the outer terminal plate 132B is located between the negative cable assembly CN and the inner terminal plate 134B.

Reference is made again to FIG. 2. As shown in FIG. 2, in this embodiment, the power cable assembly CA further includes cable fixing elements for connecting cables, the outer terminal plate 132A, and the outer terminal plate 132B, for example, crimping ring 140A and a crimping ring 140B. The crimping ring 140A and the crimping ring 140B are formed of deformable metal and capable of being deformed and clamped the cable therein. The crimping ring 140A and the crimping ring 140B have a plurality of heat fins formed on or attached to the outer facing surface thereof. Each of the crimping ring 140A and the crimping ring 140B has two through holes allowing fixing part F to be penetrated therethrough.

The crimping ring 140A is disposed on the positive cable assembly CP, and the crimping ring 140B is disposed on the negative cable assembly CN. In some embodiments, one of the two sealing sleeves BD is located between the positive cable assembly CP and the crimping ring 140A, and the other one of the two sealing sleeves BD is located between the negative cable assembly CN and the crimping ring 140B.

The power cable assembly CA further includes a plurality of fixing part sets F, for example, screw (e.g., stud) with screw cap (e.g., nut), or rivet. The fixing part sets F are configured to fix the positive terminal set 130A and the crimping ring 140A together. The fixing part sets F are further configured to secure the negative terminal set 130B with the crimping ring 140b.

As shown in FIG. 2, the positive cable assembly CP and the negative cable assembly CN respectively include a plurality of positive wires WP and a plurality of negative wires WN. A portion of the positive wires WP and a portion of the negative wires WN respectively protrude from the crimping ring 140A and the crimping ring 140B. As shown in FIG. 1 and FIG. 2, the inner terminal plate 134A of the positive terminal set 130A and the inner terminal plate 134B of the negative terminal set 130B face to each other in the trench T.

Reference is made again to FIG. 2. As shown in FIG. 2, in this embodiment, the connector 100 further includes a partition plate 118. The partition plate 118 is disposed in the main body portion 112. More specifically, the partition plate 118 protrudes beyond the main body portion 112. In some embodiments, the partition plate 118 extends downward from the main body portion 112. As shown in FIG. 1 and FIG. 2, the positive terminal set 130A and the negative terminal set 130B are separated by the partition plate 118. The extending cover plate 117 extends from the main body portion 112 and is connected to the partition plate 118. In other words, the extending cover plate 117 and the partition plate 118 protrude beyond the main body portion 112. In this embodiment, the housing 110 further has a first space S1 and a second space S2. The second space S2 is separated from the first space S1. More specifically, the first space S1 is defined by the main body portion 112, the wing portion 115, the extending cover plate 117, and the partition plate 118, whereas the second space S2 is defined by the main body portion 112, the wing portion 116, the extending cover plate 117, and the partition plate 118. As shown in FIG. 1 and FIG. 2, the first space S1 accommodates a portion of the positive cable assembly CP, and the second space S2 accommodates a portion of the negative cable assembly CN.

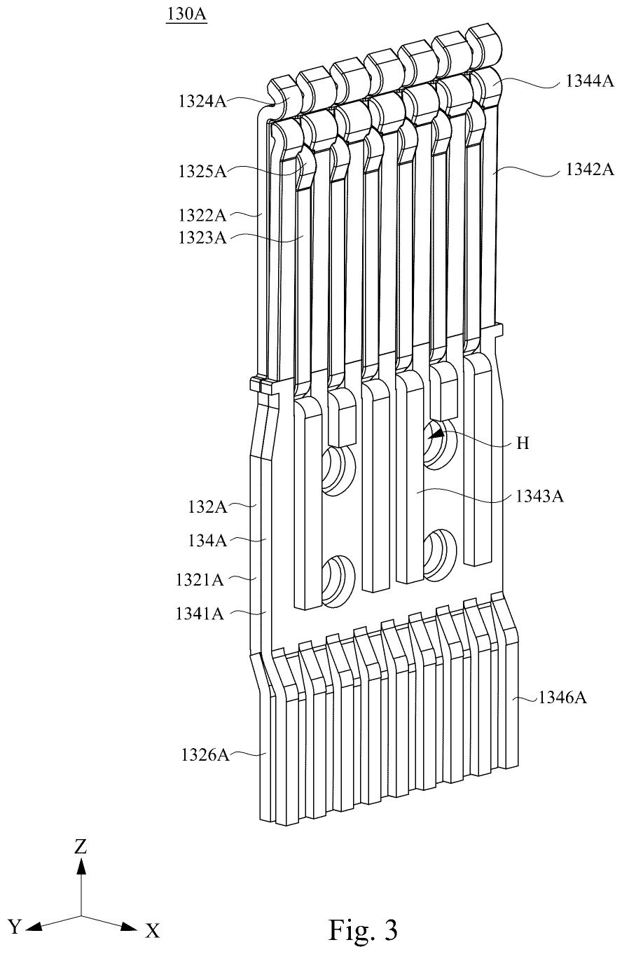

Reference is made to FIG. 3. FIG. 3 is a perspective view of the positive terminal set 130A in accordance with an embodiment of the present disclosure. It is noted that the structural configuration of the positive terminal set 130A is substantially the same as the structural configuration of the negative terminal set 130B. For simplicity, the present disclosure only discusses the positive terminal set 130A in detail and omits the negative terminal set 130B. As shown in FIG. 3, in this embodiment, the positive terminal set 130A (or the negative terminal set 130B) includes the outer terminal plate 132A and the inner terminal plate 134A combined with the outer terminal plate 132A. The outer terminal plate 132A includes an outer fixing portion 1321A, a plurality of first elastic arm 1322A, a plurality of second elastic arm 1323A, a plurality of first contacting portions 1324A, a plurality of second contacting portions 1325A, and a plurality of first dissipation fins 1326A. The first elastic arms 1322A and the second elastic arms 1323A are extended from the outer fixing portion 1321A. The first contacting portions 1324A are individually bent from the first elastic arms 1322A. In some embodiments, the first contacting portions 1324A are located at an end of the first elastic arms 1322A away from the main body portion 112 of the housing 110. The second contacting portions 1325A are individually bent from the second elastic arms 1323A. In some embodiments, the second contacting portions 1325A are located at an end of the second elastic arms 1323A away from the main body portion 112 of the housing 110.

Reference is made again to FIG. 3. As shown in FIG. 3, in this embodiment, the inner terminal plate 134A includes an inner fixing portion 1341A, a plurality of third elastic arm 1342A, a plurality of extruded portions 1343A, a plurality of third contacting portions 1344A, and a plurality of second dissipation fins 1346A. The inner fixing portion 1341A is secured with the outer fixing portion 1321A. The third elastic arms 1342A are extended from the inner fixing portion 1341A. The extruded portions 1343A are extended and bent from the inner fixing portion 1341A. In some embodiments, the extruded portions 1343A are raised above the inner fixing portion 1341A. The third contacting portions 1344A overlap with the first elastic arms 1322A. The third contacting portions 1344A are individually bent from the third elastic arms 1342A. In some embodiments, the third contacting portions 1344A are located at an end of the third elastic arms 1342A away from the main body portion 112 of the housing 110. In some embodiments, the first contacting portions 1324A, the second contacting portions 1325A, and the third contacting portions 1344A are individually and parallelly arranged in a direction (e.g., y-direction). As shown in FIG. 3, the positive terminal set 130A has a plurality of fixing holes H. The fixing holes H are configured to be coupled to the fixing part sets F.

In some embodiments, the quantity of the first elastic arms 1322A, the second elastic arms 1323A, the third elastic arms 1342A, the first contacting portions 1324A, the second contacting portions 1325A, the third contacting portions 1344A, the first dissipation fins 1326A, and the second dissipation fins 1346A may be singular or plural. The present disclosure is not intended to limit the quantity of the first elastic arms 1322A, the second elastic arms 1323A, the third elastic arms 1342A, the first contacting portions 1324A, the second contacting portions 1325A, the third contacting portions 1344A, the first dissipation fins 1326A, and the second dissipation fins 1346A.

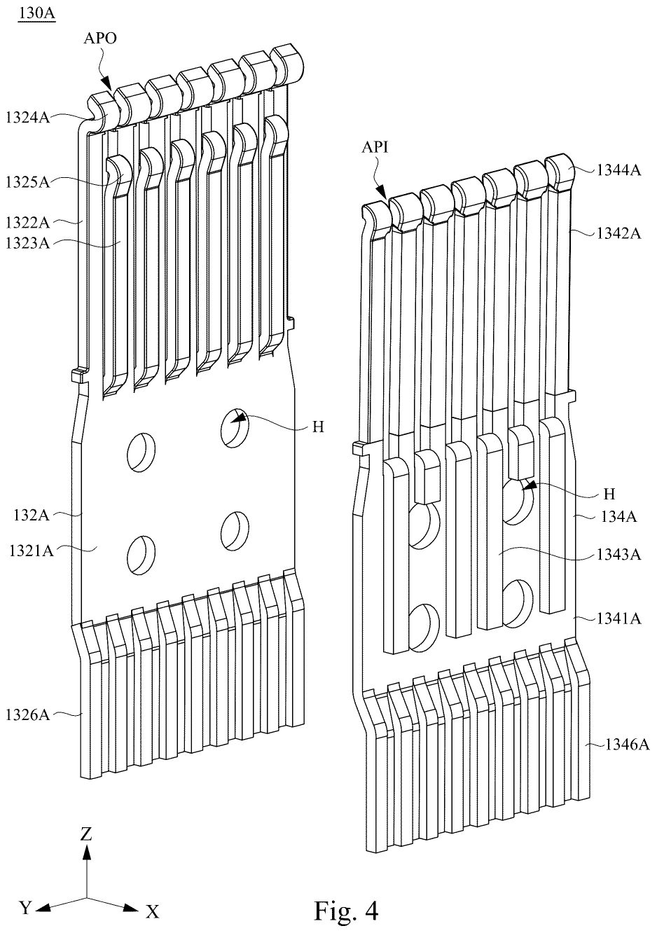

FIG. 4 is an exploded view of the positive terminal set 130A in accordance with an embodiment of the present disclosure. As shown in FIG. 4, in this embodiment, the second elastic arms 1323A are individually separated from the first elastic arms 1322A. The first dissipation fins 1326A are separated from the first elastic arms 1322A and the second elastic arms 1323A. More specifically, the first elastic arms 1322A and the second elastic arms 1323A are located at a top end of the outer terminal plate 132A, whereas the first dissipation fins 1326A are located at a bottom end of the outer terminal plate 132A. A plurality of outer apertures APO are formed between each two of the first elastic arms 1322A. In some embodiments, the second elastic arms 1323A are aligned with and cover a majority portion of the outer apertures APO. As shown in FIG. 2 and FIG. 4, in this embodiment, the first dissipation fins 1326A and the second dissipation fins 1346A protrude away from the bottom of the main body portion 112. The second contacting portions 1325A are separated from the first contacting portions 1324A. The second dissipation fins 1346A are separated from the third elastic arms 1342A. More specifically, the third elastic arms 1342A are located at a top end of the inner terminal plate 134A, whereas the second dissipation fins 1346A are located at a bottom end of the inner terminal plate 134A. A plurality of inner apertures API are formed between each two of the third elastic arms 1342A. In some embodiments, the second elastic arms 1323A are embedded into the inner apertures API respectively. As shown in FIG. 4, the outer terminal plate 132A has the fixing holes H, and the inner terminal plate 134A has the fixing holes H as well. It is noted that the outer terminal plate 132B and the inner terminal plate 134B of the negative terminal set 130B respectively have the fixing holes H.

In some embodiments, the second elastic arms 1323A are raised from the first elastic arms 1322A.

In some embodiments, the extruded portions 1343A correspond to the inner apertures API. In some embodiments, the extruded portions 1343A are located below the inner apertures API.

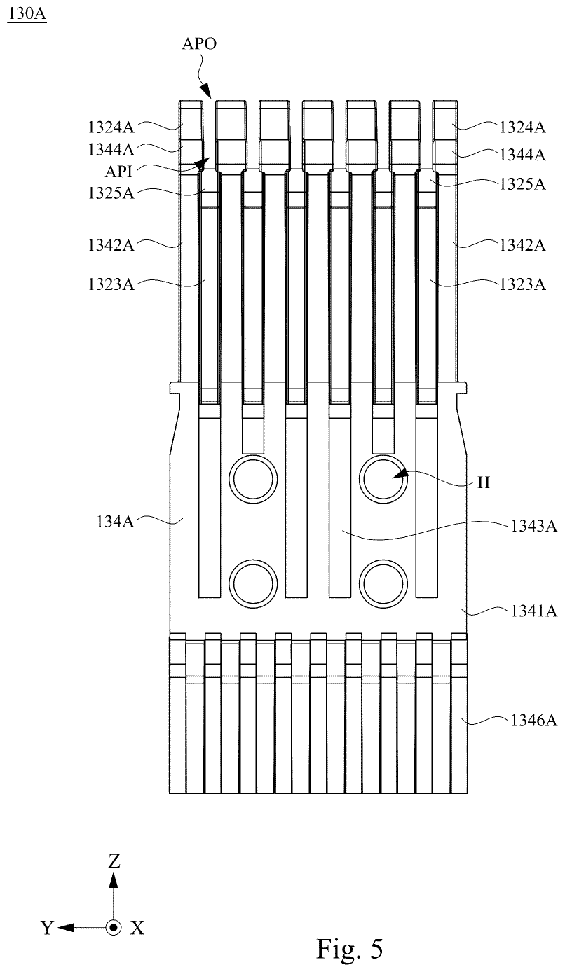

Reference is made to FIG. 5. FIG. 5 is a sided view of the positive terminal set 130A in accordance with an embodiment of the present disclosure. As shown in FIG. 5, in this embodiment, each of the second contacting portions 1325A is located between two of the adjacent first contacting portions 1324A. Each of the second contacting portions 1325A is located between two of the adjacent third contacting portions 1344A. As shown in FIG. 5, the fixing holes H of the outer terminal plate 132A are aligned with the fixing holes H of the inner terminal plate 134A. In some embodiments, a diameter of each of the fixing holes H of the outer terminal plate 132A is less than a diameter of each of the fixing holes H of the inner terminal plate 134A. In some embodiments, the inner apertures API are aligned with the outer apertures APO along a direction (e.g., x-direction).

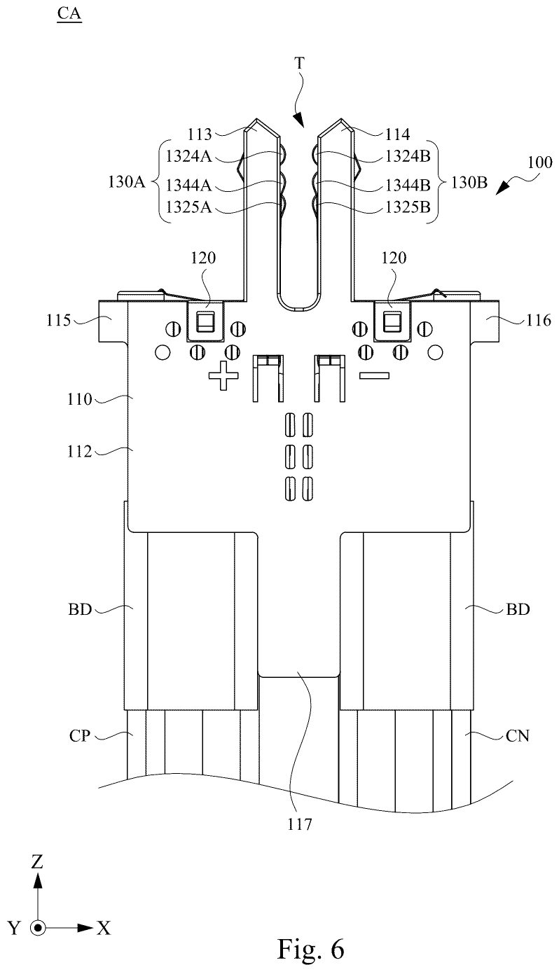

Reference is made to FIG. 6. FIG. 6 is a sided view of the power cable assembly CA in accordance with an embodiment of the present disclosure. As shown in FIG. 6, in this embodiment, the negative terminal set 130B includes a plurality of first contacting portions 1324B, a plurality of second contacting portions 1325B, and a plurality of third contacting portions 1344B. The first contacting portions 1324A correspond to the first contacting portions 1324B. The second contacting portions 1325A correspond to the second contacting portions 1325B. The third contacting portions 1344A correspond to the third contacting portions 1344B. As shown in FIG. 6, the third contacting portions 1344A are located between the first contacting portions 1324A and the second contacting portion 1325A. In some embodiments, the third contacting portions 1344A are located between the first contacting portions 1324A and the second contacting portion 1325A in a side view. More specifically, the side view is defined as a view being viewed along a direction which is coplanar with another direction from the first extending portion 113 to the second extending portion 114. In some embodiments, the side view may be a view which is viewed along a direction (e.g., y-direction) parallel to an xy-plane, as shown in FIG. 6. Similarly, the third contacting portions 1344B are located between the first contacting portions 1324B and the second contacting portion 1325B in the side view as shown in FIG. 6. The first contacting portions 1324A, the second contacting portions 1325A, and the third contacting portions 1344A are raised away from the first extending portion 113. The first contacting portions 1324B, the second contacting portions 1325B, and the third contacting portions 1344B are raised away from the second extending portion 114.

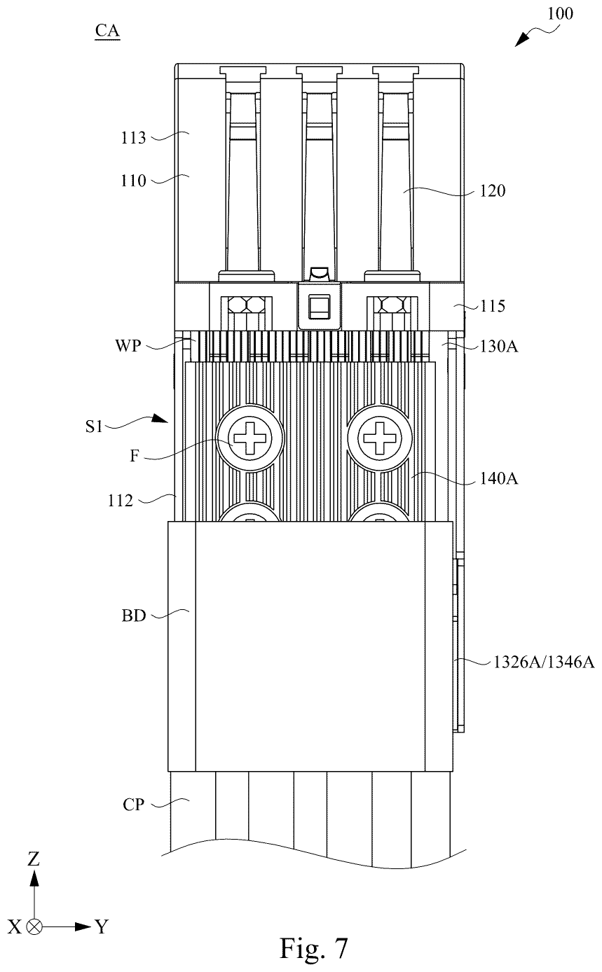

Reference is made to FIG. 7. FIG. 7 is another sided view of the power cable assembly CA in accordance with an embodiment of the present disclosure. As shown in FIG. 7, in this embodiment, the first space S1 of the housing 110 accommodates the positive cable assembly CP, one of the two sealing sleeves BD, and the crimping ring 140A. The crimping ring 140A is exposed in the first space S1. A portion of the positive wires WP is exposed in the first space S1. The first dissipation fins 1326A are exposed in the first space S1, as well. Similarly, the second space S2 of the housing 110 accommodates the negative cable assembly CN, the other one of the two sealing sleeves BD, and the crimping ring 140B. The crimping ring 140B is exposed in the second space S2. A portion of the negative wires WN is exposed in the second space S2. The second dissipation fins 1326B are exposed in the second space S2, as well.

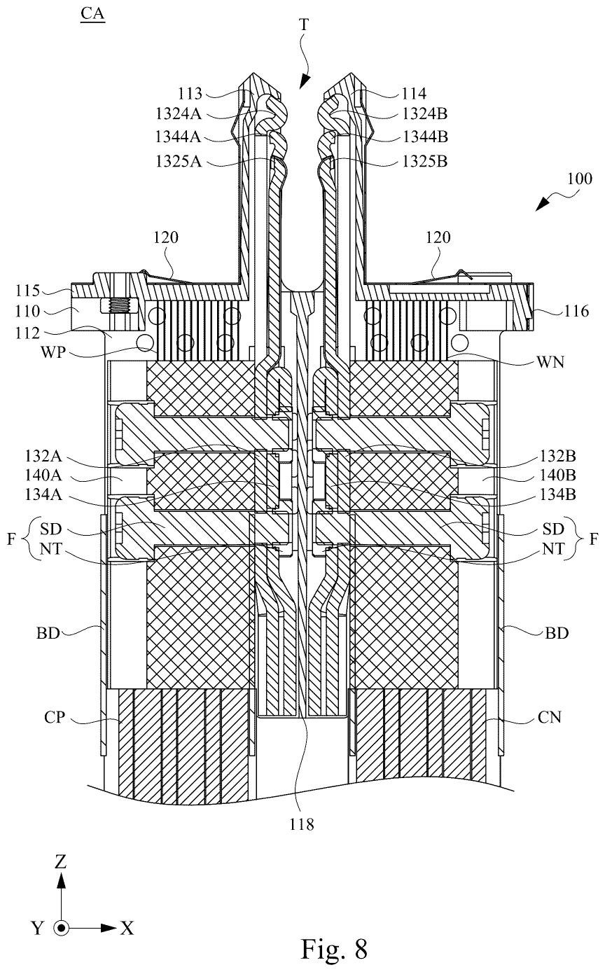

Reference is made to FIG. 8. FIG. 8 is a cross-sectional view of the power cable assembly CA in accordance with an embodiment of the present disclosure. As shown in FIG. 8, in this embodiment, the fixing part sets F pass through the fixing holes H of the outer terminal plate 132A and the fixing holes H of the inner terminal plates 134A. Similarly, the fixing part sets F pass through the fixing holes H of the outer terminal plate 132B and the fixing holes H of the inner terminal plates 134B. Each of the fixing part sets F includes a stud SD and a nut NT connected to the stud SD. The stud SD passes though the crimping ring 140A, the outer terminal plate 132A, and the inner terminal plate 134A. Similarly, the stud SD passes though the crimping ring 140B, the outer terminal plate 132B, and the inner terminal plate 134B. In some embodiments, the nut NT is located at an end of the stud SD facing the partition plate 118.

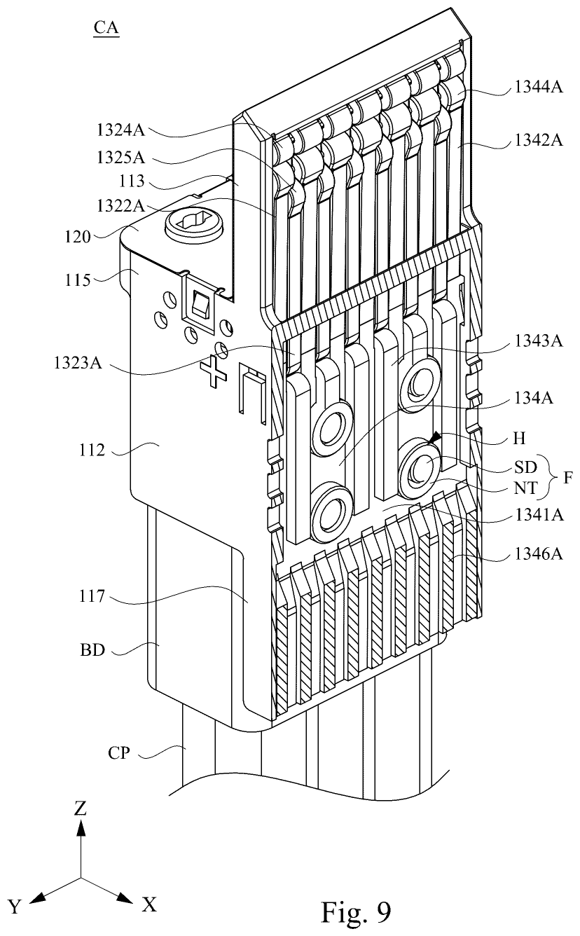

Reference is made to FIG. 9. FIG. 9 is a perspective view of the power cable assembly CA in accordance with an embodiment of the present disclosure. As shown in FIG. 9, in this embodiment, the nut NT fits in the fixing holes H of the inner terminal plate 134A. The nut NT is located between the extruded portions 1343A. In some embodiments, a thickness of the nut NT is less than a thickness of the extruded portions 1343A in a direction (e.g., x-direction).

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A power cable assembly, comprising:
a housing, comprising:
a main body portion; and
a plurality of extending portions, protruding from the main body portion, having two openings opposite to each other; and
two terminal sets embedded into the housing and exposed via the two openings of the extending portions respectively, wherein each of the two terminal sets comprises:
an outer terminal plate comprising an outer fixing portion, a plurality of first elastic arms, and a plurality of second elastic arms, wherein the first elastic arms and the second elastic arms are extended from the outer fixing portion, wherein a plurality of outer apertures are formed between each two of the first elastic arms, wherein each of the second elastic arms is aligned with and cover a majority portion of the corresponding outer apertures respectively; and
an inner terminal plate stacked with the outer terminal plate, the inner terminal plate comprising an inner fixing portion and a plurality of third elastic arms, the inner fixing portion being secured with the outer fixing portion, wherein a plurality of inner apertures are formed between each two of the third elastic arms, and each of the second elastic arms is embedded into the inner apertures respectively.

2. The power cable assembly of claim 1, wherein the outer terminal plate further comprises a plurality of first contacting portions located at an end of the first elastic arms away from the main body portion of the housing and a plurality of second contacting portions located at an end of the second elastic arms away from the main body portion of the housing, and the inner terminal plate further comprises a plurality of third contacting portions located at an end of the third elastic arms away from the main body portion of the housing.

3. The power cable assembly of claim 2, wherein the first contacting portions, the second contacting portions, and the third contacting portions are individually and parallelly arranged in a direction.

4. The power cable assembly of claim 2, wherein the third contacting portions are located between the first contacting portions and the second contacting portions.

5. The power cable assembly of claim 1, wherein the inner apertures are aligned with the outer apertures along a direction.

6. The power cable assembly of claim 1, wherein the inner terminal plate further comprises a plurality of extruded portions corresponding to the inner apertures.

7. The power cable assembly of claim 6, wherein each of the outer terminal plate and the inner terminal plate has a fixing hole, and the fixing hole of the outer terminal plate is aligned with the fixing hole of the inner terminal plate, wherein the power cable assembly further comprises a fixing part set passing through the fixing hole of the outer terminal plate and the fixing hole of the inner terminal plate, wherein the fixing part set further comprises a stud and a nut connected to the stud, and the nut is located between the extruded portions, wherein a thickness of the nut is less than a thickness of the extruded portions.

8. A power cable assembly, comprising:
a housing, comprising:
a main body portion; and
a first extending portion and a second extending portion protruding from the main body portion, wherein the first extending portion is separated from the second extending portion; and
two terminal sets respectively located on the first extending portion and the second extending portion, wherein each of the two terminal sets comprises:
an outer terminal plate comprising a plurality of first elastic arms, a plurality of first contacting portions individually bent from the first elastic arms, a plurality of second elastic arms individually separated from the first elastic arms, and a plurality of second contacting portions individually bent from the second elastic arms and separated from the first contacting portions; and
an inner terminal plate stacked with the outer terminal plate and comprising a plurality of third elastic arms overlapping with the first elastic arms and a plurality of third contacting portions individually bent from the third elastic arms,
wherein the first contacting portions, the second contacting portions, and the third contacting portions are individually and parallelly arranged in a direction.

9. The power cable assembly of claim 8, wherein the first contacting portions are located at an end of the first elastic arms away from the main body portion of the housing, the second contacting portions are located at an end of the second elastic arms away from the main body portion of the housing, and the third contacting portions are located at an end of the third elastic arms away from the main body portion of the housing.

10. The power cable assembly of claim 8, wherein the third contacting portions are located between the first contacting portions and the second contacting portions.

11. The power cable assembly of claim 8, wherein the outer terminal plate further has a plurality of outer apertures formed between each two of the first elastic arms, and the inner terminal plate further has a plurality of inner apertures formed between each two of the third elastic arms, wherein the inner apertures are aligned with the outer apertures along a direction.

12. The power cable assembly of claim 11, wherein the inner terminal plate further comprises a plurality of extruded portions corresponding to the inner apertures.

13. The power cable assembly of claim 12, wherein each of the outer terminal plate and the inner terminal plate has a fixing hole, and the fixing hole of the outer terminal plate is aligned with the fixing hole of the inner terminal plate, wherein the power cable assembly further comprises a fixing part set passing through the fixing hole of the outer terminal plate and the fixing hole of the inner terminal plate.

14. The power cable assembly of claim 13, wherein the fixing part set further comprises a stud and a nut connected to the stud, and the nut is located between the extruded portions, wherein a thickness of the nut is less than a thickness of the extruded portions.

15. A power cable assembly, comprising:
a housing, comprising:
a main body portion; and
a first extending portion and a second extending portion protruding from the main body portion, wherein the main body portion, the first extending portion, and the second extending portion jointly define a trench; and
two terminal sets respectively located on the first extending portion and the second extending portion, wherein each of the two terminal sets comprises:
an outer terminal plate comprising a plurality of first elastic arms, a plurality of first contacting portions disposed on the first elastic arms, a plurality of second elastic arms separated from the first elastic arms, and a plurality of second contacting portions disposed on the second elastic arms and separated from the first contacting portions; and
an inner terminal plate stacked with the outer terminal plate and comprising a plurality of third elastic arms overlapping with the first elastic arms and a plurality of third contacting portions disposed on the third elastic arms,
wherein the third contacting portions are located between the first contacting portions and the second contacting portions.

16. The power cable assembly of claim 15, wherein the first contacting portions are located at an end of the first elastic arms away from the main body portion of the housing, the second contacting portions are located at an end of the second elastic arms away from the main body portion of the housing, and the third contacting portions are located at an end of the third elastic arms away from the main body portion of the housing.

17. The power cable assembly of claim 15, wherein the first contacting portions, the second contacting portions, and the third contacting portions are individually and parallelly arranged in a direction.

18. The power cable assembly of claim 15, wherein the outer terminal plate further has a plurality of outer apertures formed between each two of the first elastic arms, and the inner terminal plate further has a plurality of inner apertures formed between each two of the third elastic arms, wherein the inner apertures are aligned with the outer apertures along a direction.

19. The power cable assembly of claim 18, wherein the inner terminal plate further comprises a plurality of extruded portions corresponding to the inner apertures.

20. The power cable assembly of claim 19, wherein each of the outer terminal plate and the inner terminal plate has a fixing hole, and the fixing hole of the outer terminal plate is aligned with the fixing hole of the inner terminal plate, wherein the power cable assembly further comprises a fixing part set passing through the fixing hole of the outer terminal plate and the fixing hole of the inner terminal plate, wherein the fixing part set further comprises a stud and a nut connected to the stud, and the nut is located between the extruded portions, wherein a thickness of the nut is less than a thickness of the extruded portions.
